(19) United States
(12) Patent Application Publication
(10) Pub. No.: US 2026/0363481 A1
(43) Pub. Date: Nov. 19, 2026

(54) AUTONOMOUS TREATMENT PROCESS AND APPARATUS

(71) Applicant: Koninklijke Douwe Egberts B.V., Utrecht (NL)

(72) Inventors: Dennis Christiaan Kemp, Nieuw-Vennep (NL); Eduard Pater, Utrecht (NL); Koen Standaar, Utrecht (NL)

(21) Appl. No.: 19/490,825

(22) PCT Filed: Jun. 6, 2024
(86) PCT No.: PCT/EP2024/065625

§ 371 Date: Dec. 5, 2025

(30) Foreign Application Priority Data
Jun. 8, 2023 (GB) 2308526.9

(51) Int. Cl. A47J 31/60; A47J 31/40; A47J 31/46; A47J 31/52

(52) U.S. Cl. CPC A47J 31/60; A47J 31/40; A47J 31/46; A47J 31/525

(57) ABSTRACT

An autonomous treatment process for a beverage preparation machine and a beverage preparation machine are provided which automatically triggers the beverage preparation machine into a treatment mode dependent upon at least one use parameter or a time schedule, causing deployment of at least one fluid collection trough relative to at least one fluid dispensing outlet to clean the machine and the at least one fluid dispensing outlet.

### TECHNICAL FIELD OF THE INVENTION

The present invention relates generally to the field of beverage preparation machines and more particularly to an autonomous treatment process and apparatus for a beverage machine.

### BACKGROUND TO THE INVENTION

Cleaning apparatus and methods are known in the field of beverage preparation machines.

One example is provided in International Patent Publication No. WO2018208156 which describes an apparatus for the preparation of a beverage, including at least one beverage outlet nozzle for discharging the beverage into a beverage container, characterized in that the apparatus includes a cleaning structure for cleaning an exterior surface of the beverage outlet nozzle. With such cleaning structure, residues and ingredients of beverages may be removed from the exterior surface of the beverage outlet nozzle.

This document describes an apparatus which cleans the exterior of a beverage dispensing nozzle by locating the nozzle in a receptacle and expelling cleaning fluid through the nozzle such that the cleaning fluid is directed over the sides of the nozzle and out of the receptacle in an overflow configuration. The cleaning structure is connected to a suspension arm via a first connecting arm and a second connecting arm, the first connecting arm is near a proximal end pivotally connected to an upper part of the suspension arm via an upper pivot point and near a distal end of the first connecting arm pivotally connected to a proximal end of the cleaning structure via a proximal pivot point and the second connecting arm is near a proximal end pivotally connected to a lower part of the suspension arm via a lower pivot point and near a distal end of the second connecting arm pivotally connected to a distal end of the cleaning structure via a distal pivot point.

International Patent Publication No. WO2018208157 describes hot beverage dispensing device having a cleaning module and a method for cleaning a hot beverage dispensing device. The method for cleaning a hot beverage dispensing device comprises a sequence of at least a first rinsing step, a treatment step and a second rinsing step. The first rinsing step comprises rinsing at least part of the beverage preparation module and the beverage outlet with a rinsing fluid having a first rinsing fluid temperature. The treatment step comprises treating at least part of the beverage preparation module and the beverage outlet with a treatment fluid. The treatment fluid has a temperature that is higher than the first rinsing fluid temperature. The second rinsing step comprises rinsing at least part of the beverage preparation module and the beverage outlet with a rinsing fluid having a second rinsing fluid temperature. In addition to the water inlet, hot beverage preparation module and beverage outlet referred to above which serve to deliver a prepared beverage to a receptacle in a first operational mode of the device, the improved hot beverage device further comprises a cleaning module. In a second operational mode of the device, the cleaning module subsequently performs a first rinsing step, a treatment step and a second rinsing step as specified above.

There is therefore a need for a less time consuming and effective cleaning system for a beverage preparation machine which allows an external cleaning of parts of the machine that are in contact with food stuff.

In prior art devices and methods, the operators of beverage preparation machines need to be trained in order to perform the cleaning process and need to check on the machine regularly. This may result in a high effort for the operators and high labour costs, furthermore this may represent an inconvenience for the consumers since the machine is not available during the cleaning cycle.

Existing design solutions currently on the market do not satisfy the above requirements and the new design below solves all of the current issues.

### SUMMARY OF THE INVENTION

According to one broad aspect of the invention, there is provided an autonomous treatment process for a beverage preparation machine including the steps of:
a. Automatically triggering the beverage preparation machine into a treatment mode, the treatment mode implementing a treatment method comprising the sub-steps of:
   i. Deploying at least one fluid collection trough from a beverage dispensing position separated from at least one fluid dispensing outlet of the beverage preparation machine to a treatment position below the at least one fluid dispensing outlet of the beverage preparation machine;
   ii. Flushing the at least one fluid dispensing outlet and at least one mixing chamber of the beverage preparation machine with a flushing fluid;
   iii. Retract the at least one fluid collection trough from the treatment position to the beverage dispensing position; and
b. Returning the beverage preparation machine to the dispensing mode.

The autonomous treatment process may further include the steps of:
Treating at least one fluid receptacle in the beverage preparation machine with a treatment fluid in a treatment step, following the flushing step (ii); and
Second flushing the at least one fluid receptacle with a flushing fluid in a second flushing step, following the treatment step and before the retracting step (iii).

According to a further aspect of the invention, there is provided a beverage preparation machine for an autonomous treatment process, the beverage preparation machine comprising at least one fluid dispensing outlet and at least one fluid collection trough positioned relative to the at least one fluid dispensing outlet and moveable between a dispensing position separated from at least one fluid dispensing outlet to a treatment position below at least one outlet wherein when in the treatment position, the at least one fluid dispensing outlet is positioned within the at least one fluid collection trough to clean an outer surface of the at least one fluid dispensing outlet.

According to still a further aspect of the invention, there is provided an autonomous treatment beverage preparation machine, the beverage preparation machine comprising at least one fluid dispensing outlet and at least one fluid collection trough positioned relative to the at least one fluid dispensing outlet and moveable between a dispensing position separated from at least one fluid dispensing outlet to a treatment position below at least one outlet wherein when in the treatment position, the at least one fluid dispensing outlet is positioned within the at least one fluid collection trough to clean an outer surface of the at least one fluid dispensing outlet, automatically triggering a treatment mode in which the at least one fluid collection trough deploys from a dispensing position separated from at least one fluid dispensing outlet of the beverage preparation machine to a treatment position below the at least one fluid dispensing outlet of the beverage preparation machine, an outlet and mixing chamber of the beverage preparation machine is flushed with a flushing fluid, the at least one fluid collection trough is retracted from the treatment position to the dispensing position and the beverage preparation machine is returned to the dispensing mode.

The autonomous treatment beverage preparation machine may treat at least one fluid receptacle in the beverage preparation machine with a treatment fluid after the flushing step. The at least one fluid receptacle may be flushed with a flushing fluid, after the treating with the treatment fluid and prior to retraction of the at least one fluid collection trough from the treatment position.

Providing an autonomous cleaning process for a beverage preparation machine, and a beverage preparation machine for an autonomous treatment process as described above means that the treatment can be started without human interaction and at a frequency based on the use of the machine. The provision of at least one fluid collection trough ensures that at least one fluid dispensing outlet is positioned within the at least one fluid collection trough to clean an outer surface of the at least one fluid dispensing outlet but that the fluid collection trough does not otherwise obstruct operation of the beverage preparation machine.

In the present description, the terms ‘treat’, ‘treatment’ or ‘treating’ is intended to cover cleaning and/or descaling although different components of the beverage preparation machine may be flushed, cleaned and/or descaled.

The autonomous cleaning process for a beverage preparation machine, and a beverage preparation machine for an autonomous treatment process as described herein could be used for beverage preparation machines using liquid ingredients, such as liquid coffee, milk and/or chocolate, but also for beverage preparation machines using one or more instant ingredients, capsules/pad and/or roast and/or ground coffee. Without wishing to be limited by theory, the basic proposition for the autonomous cleaning process described herein is that it could be used with any ingredient spout/outlet for which cleaning or other treatment is required or desired.

The beverage preparation machine may preferably prepare and dispense beverages. The machine may dispense various types of beverages, typically characterised according to the component ingredients. For example, the beverage preparation machine may prepare beverages which are water-based, milk-based and different types of milk may also be used. The beverage preparation machine may prepare beverages which are water-based which then have milk added thereto. Additionally, different beverages may be prepared and dispensed such as soup for example.

The beverage preparation machine may utilise liquid ingredients and/or powdered ingredients.

The beverage preparation machine will preferably include various components provided as a part of one or more beverage preparation and dispensing circuits provided within the machine. For example, the machine may be a hot beverage preparation and dispensing circuit and/or a cold or cooled beverage preparation and dispensing circuit. In some embodiments, the hot circuit and the cold circuit may interact with one another.

The beverage preparation machine may include a boiler to provide heated fluid. The beverage preparation machine may include a cold or cool treatment component or subsystem to create chilled or cooled beverages or beverage components.

The beverage preparation machine may include one or more mixing chambers to mix beverage ingredients to create a beverage to be dispensed. The one or more mixing chambers may include agitation or stirring devices or systems to agitate or stir the ingredients once the ingredients have been provided into the mixing chamber.

The beverage preparation machine may include one or more chilled storage units in which one or more ingredients may be stored.

The autonomous treatment process may be based on at least one parameter relating to the use of the beverage preparation machine. The beverage preparation machine may monitor at least one use parameter whilst in a dispensing mode. The autonomous treatment process may be triggered according to use of one or more of the ingredients. For example, if the beverage preparation machine is configured to use milk as an ingredient, any beverage preparation circuit which utilises milk as an ingredient may require treatment more often for example once each day than a beverage preparation circuit which utilises only water, which may only require treatment once per week. Further, any circuit which prepares and dispenses cold or cooled beverages may require treatment more often than a circuit which provides only hot beverages. For example, a cold or cooled beverage circuit may require treatment once each day whereas a hot circuit may only require treatment once every few days or once per week.

The beverage preparation machine may be triggered into the treatment mode based on the level of use. For example, more intense use which creates a high throughput of material through the beverage preparation machine may trigger the treatment mode more often.

The treatment mode may be triggered based on the at least one use parameter in combination with at least one other parameter which may affect the operational efficiency of the beverage preparation machine. For example, water hardness may influence operational efficiency and therefore, a machine used in combination with harder water may require more frequent descaling than a machine used with softer water where use is at the same level of throughput.

The beverage preparation machine will preferably be provided with a controller associated with one or more sensors to sense a flow or use of ingredients in order to measure the use of ingredients and/or any other parameter related to the ingredients, such as for example water hardness.

In an embodiment, in which the beverage preparation machine, and in particular any controller provided to control the autonomous cleaning process is provided with a defined threshold of use to trigger the autonomously process.

The autonomous cleaning process may be triggered based on time as a use parameter. In one form, if a defined threshold of use is not reached, then the autonomous cleaning process may be triggered according to a default time period. For example, the beverage preparation machine may be triggered into the treatment mode based on a time schedule.

In one embodiment, the treatment mode may be triggered based on the at least one use parameter of the beverage preparation machine and also treatment schedule based on time. The treatment based on the at least one use parameter of the beverage preparation machine may take precedence over a schedule of treatment based on time, with the schedule of treatment based on time being a default backup. For example, the beverage preparation machine may have a default schedule of treatment which triggers the treatment mode based on hours of operation (the treatment mode may be triggered overnight for example), or if the beverage preparation machine is idle for a period of time (this may be partially based on the ingredient used, as milk may require more frequent cleaning/flushing than water). Further, the beverage preparation machine may be triggered into the treatment mode on a time basis, such as once very hour of use for example.

More frequent treatment may be triggered based on ingredient use as a parameter, but with the treatment schedule based on time as an underlying or backup treatment schedule. The treatment schedule based on time may occur regardless of primary use parameters such as ingredient use. Alternatively, the treatment schedule based on time may only be used if a defined threshold of use is not reached between time scheduled treatments.

The method for treatment a beverage preparation machine may comprise a sequence of at least a flushing step. The flushing step preferably comprises flushing at least part of the beverage preparation machine or component and the beverage outlet with a flushing fluid. The beverage preparation machine may be flushed and then returned to the dispensing mode.

The method for treatment a beverage preparation machine may comprise a sequence of at least a first flushing step, a treatment step and a second flushing step. The first flushing step preferably comprises flushing at least part of the beverage preparation machine or component and the beverage outlet with a flushing fluid.

The treatment step preferably comprises treating at least part of the beverage preparation machine or component and the beverage outlet with a treatment fluid. The treatment fluid may have a temperature which is higher or lower than the flushing fluid temperature.

The second flushing step may comprise flushing at least part of the beverage preparation machine or component and the beverage outlet with a flushing fluid.

In a preferred form, at least one controller associated with beverage preparation machine will monitor the use and trigger the change in modes. A warning may be given. For example, a warning with a “time remaining before treatment” may be provided. Alternatively, the warning may be or include a number of beverages which can be dispensed before treatment mode is triggered.

Once the treatment mode has been triggered, the at least one fluid collection trough is preferably deployed from the beverage dispensing position to the treatment position. In the beverage dispensing position, the at least one fluid connection trough is preferably located adjacent to, but separated from the at least one fluid dispensing outlet of the beverage preparation machine. The at least one fluid collection trough is preferably deployed to the treatment position before any treatment begins in order to catch any flushing/treatment fluid from the at least one fluid dispensing outlet and/or any remaining material from the beverage preparation circuit.

The deployment of the at least one fluid collection trough may cause movement in the at least one fluid dispensing outlet. The at least one fluid dispensing outlet may be mounted for movement relative to a mounting portion of the beverage preparation machine. In many embodiments, the at least one fluid dispensing outlet will be substantially vertically oriented. The at least one fluid dispensing outlet may be movable between a lowered, dispensing position and a raised position. The deployment of the at least one fluid collection trough may cause the at least one fluid dispensing outlet to be raised and then to lower again once the at least one fluid dispensing outlet is positioned above the at least one fluid collection trough.

The at least one fluid dispensing outlet may be biased into a lowered, dispensing position and movement of the at least one fluid collection trough may force the at least one fluid dispensing outlet upwardly against the bias and then the bias may preferably return the at least one fluid dispensing outlet to the lowered position. In the dispensing position, the at least one fluid dispensing outlet is preferably in the lowered position but outside the at least one fluid collection trough. In the treatment position, the at least one fluid dispensing outlet is preferably in the lowered position but inside the at least one fluid collection trough. The deployment of the at least one fluid collection trough may cause the at least one fluid dispensing outlet to be raised then lowered into the treatment position and retraction of the at least one fluid collection trough may cause the at least one fluid dispensing outlet to be raised then lowered into the fluid dispensing position.

In one configuration, the at least one fluid dispensing outlet may have a tapered lower end. In a preferred form, the at least one fluid dispensing outlet may have a V-tapered end with a downwardly angled end portion on a side facing the at least one fluid collection trough and an upwardly angled end portion on a side facing away from the at least one fluid collection trough. The provision of the angled end portions on the at least one fluid dispensing outlet may cause the at least one fluid dispensing outlet to be raised against the bias by the movement of the at least one fluid collection trough.

The at least one fluid collection trough may have a tapered outer end. In a preferred form, the at least one fluid collection trough may have an inverted V-tapered end with an outer wall or portion which is angled upwardly and away from the at least one fluid dispensing outlet and an inner wall or portion which is angled downwardly and away from the at least one fluid dispensing outlet.

One or more outlets may be provided for movement together. In one embodiment, a dual (or more) outlet assembly may be provided with a pair (or more) of outlets provide side by side but as a part of one assembly, so the outlets move together rather than separately.

In another embodiment, an abutment tab may be provided on an outer or forward wall of the fluid collection trough. The abutment tab may be provided on an outer side thereof and facing the outlets/outlet assembly and extending away from the fluid collection trough. The abutment tab may have a forward abutment portion. The abutment tab may have any shape. For example, the abutment tab may have an angled wall which is angled upwardly away from the outer wall of the fluid collection trough and which has a forward abutment apex. Alternatively, a rounded abutment tab may be provided.

The outlet assembly may include a corresponding abutment tab. The abutment tab on the outlet assembly may be positioned to face the abutment tab on the fluid collection trough. The abutment tab on the outlet assembly may have a pair of opposed ramped surfaces, namely an inner ramp surface and an outer ramp surface. The inner ramp surface preferably faces the fluid collection trough and is aligned with the abutment tab on the fluid collection trough.

In use and as the fluid collection trough is driven outwardly from the dispensing position to the treatment position, the abutment tab may abut the inner ramp surface and as the deployment outwardly continues, the abutment tab preferably slides over the inner ramp surface, which in turn forces the outlet/outlet assembly upwardly, allowing a forward or outer wall of the fluid collection trough to pass under the preferably biased outlet/outlet assembly. Once the forward or outer wall of the fluid collection trough has passed beneath the outlet/outlet assembly, the abutment may be lost and the bias forces the preferably biased outlet/outlet assembly downwardly to be located within the fluid collection trough for treatment.

In moving the fluid collection trough of this configuration from the treatment position to the dispensing position, the reverse preferably occurs, with the inner side of the forward or outer wall of the fluid collection trough abuts the outer ramp surface of the abutment tab on the preferably biased outlet/outlet assembly and as the movement inwardly continues, the inner side of the forward or outer wall of the fluid collection trough slides over the outer ramp surface, which in turn forces the preferably biased outlet/outlet assembly, allowing the forward or outer wall of the fluid collection trough to pass under the preferably biased outlet/outlet assembly. Once the forward or outer wall of the fluid collection trough has passed beneath the preferably biased outlet/outlet assembly, the abutment is lost and the bias forces the preferably biased outlet/outlet assembly downwardly to be located in the dispensing position once again, with the fluid collection trough stored spaced from the preferably biased outlet/outlet assembly.

In one form, the at least one fluid collection trough will move laterally in a horizontal direction. Preferably the movement of the at least one fluid collection trough will be reciprocal between the beverage dispensing position and the treatment position. Any type of drive mechanism may be used to move the at least one fluid collection trough.

In an alternative embodiment, the at least one fluid collection trough may move around the at least one dispensing outlet. The at least one fluid dispensing outlet may be fixed in position. The at least one fluid collection trough may move laterally under the at least one dispensing outlet and then upwardly into a treatment position and then downwardly and away from the at least one dispensing outlet to clear the outlet for use in the dispensing position.

As mentioned above, the at least one fluid dispensing outlet may be biased downwardly. Any biasing mechanism may be used for example one or more springs, rams or piston and cylinder arrangements.

The at least one fluid collection trough may be provided with a tab or similar formation to abut a portion of the at least one fluid dispensing outlet or assembly to force the at least one fluid dispensing outlet upwardly as the at least one fluid collection trough passes beneath the at least one fluid dispensing outlet, between the beverage dispensing position and the treatment position and vice versa.

According to a preferred embodiment, following deployment of the at least one fluid collection trough, flushing step may occur in which the at least one fluid dispensing outlet and at least one mixing chamber of the beverage preparation machine is flushed with a flushing fluid. An initial flushing step may occur after deployment, and before treatment. An initial flushing step may flush any leftover or remaining fluid from one or more beverage dispensing circuits of the beverage dispensing machine before treatment occurs.

At least the at least one fluid dispensing outlet is flushed. At least one mixing chamber is preferably also flushed. Where at least one mixing chamber is flushed, preferably the flush proceeds until the at least one mixing chamber overflows in order to ensure that the flushing has reached at least the normal use level of the at least one mixing chamber.

Once the initial flush step has been completed, if the treatment to be undertaken is a cleaning step, then any outlet valve from the at least one mixing chamber is preferably closed in order to allow the at least one mixing chamber to be filled with cleaning fluid cleaning fluid may then be introduced into the at least one mixing chamber. The cleaning fluid may be or include a cleaning agent and/or water. Where a mixture is used, an amount of cleaning agent will preferably be dosed into an amount of water introduced into the at least one mixing chamber. The cleaning agent will preferably be dosed into the water inlet to the at least one mixing chamber via needle valve in order to prevent the Venturi effect drawing cleaning agent out during normal beverage dispensing operation.

A dosing pump may be used to dose the cleaning agent into the at least one mixing chamber. In a preferred form, the cleaning agent is dosed into the water inlet. In a preferred form, the dosing pump may be operated for a period in the reverse direction at the end of the dosing step in order to prevent cleaning agent being drawn into the water inlet during normal beverage dispensing operation.

Preferably, sufficient cleaning fluid is provided to fill the at least one mixing chamber. In a preferred embodiment, sufficient cleaning fluid is used to overflow the at least one mixing chamber in order to ensure that the cleaning fluid fills the at least one mixing chamber to above the normal use level.

The treatment step may include a soaking step in which cleaning fluid is left in the at least one mixing chamber. Preferably, in any soaking step, the cleaning fluid will remain in the at least one mixing chamber for a period of time before being emptied.

An agitator or stirring apparatus associated with the at least one mixing chamber may be operated during a cleaning step/soaking step to provide agitation or turbulence in the cleaning fluid within the at least one mixing chamber. When operated during a cleaning step/soaking step, and agitator or stirring apparatus may be operated at a low speed.

Once the cleaning step and/or soaking step has been completed, an outlet valve from the at least one mixing chamber is preferably opened to empty the at least one mixing chamber. An agitator or stirring apparatus associated with the at least one mixing chamber may be operated during the emptying of the at least one mixing chamber. Preferably, the agitator or stirring apparatus may be operated at a medium speed during the emptying of the at least one mixing chamber.

Once the at least one mixing chamber has been emptied of cleaning fluid, the outlet valve is preferably closed.

Following closing of the outlet valve, the at least one mixing chamber may undergo a flushing step in which the at least one mixing valve is flushed with a flushing fluid. This may be a second flush to flush the at least one mixing chamber of any remaining cleaning fluid. Preferably, the second flushing step may occur to overflow the at least one mixing chamber to ensure that the mixing chamber is flushed completely.

The cleaning/soaking step may occur more than once in any cleaning cycle stop for example, for beverages which include milk, the cleaning/soaking step may occur more than once but may be undertaken only once for beverages which are water-based such as tea or coffee for example.

Once the second flushing step has been completed, the at least one fluid collection trough may then be moved or retracted from the treatment position to the beverage dispensing position and the beverage preparation machine returned to the normal, dispensing mode.

In an alternative to the cleaning process described above, one or more other treatment processes may be undertaken. For example, the autonomous treatment process may be a descaling process instead of or as well as a cleaning process.

In a preferred descaling process, the at least one fluid collection trough is deployed. At least one fluid dispensing outlet and at least one mixing chamber of the beverage preparation machine can then be flushed with a flushing fluid.

In the treating step, when the beverage preparation machine is being descaled, descaling fluid may be introduced into the water system of the beverage preparation machine. The descaling fluid may be or include a descaling agent. The descaling agent may be dosed into carrier such as water. The descaling agent may be dosed into the carrier using a dosing pump.

The water system of the beverage preparation machine may include one or more process components, such as the boiler, an air break tank, other reservoir, or one or more valves, as well as connecting fluid conduits which may need descaling.

The water system or one or more process components thereof may be filled with descaling fluid. In a preferred form, a reservoir within the water system such as the boiler, an air break tank, or other reservoir will be filled. This filling may occur to overflow in order to ensure that the descaling fluid reaches the normal operating or fill level of the reservoir.

During any descaling process, the temperature of the water in the boiler may be changed, for example reduced.

The descaling process may include a soaking step in which the descaling fluid remains in the reservoir for a period of time.

During the descaling process, one or more outlet valves from the reservoir may be opened during the descaling process. Preferably, at least one outlet valve from the reservoir may be opened and then closed at one or more times during the descaling process to descaled any valves associated with the reservoir. If this occurs, additional descaling agent and/or water may be added into the reservoir to maintain the level of descaling fluid within the reservoir.

At the end of the descaling process, the reservoir will preferably be drained of descaling fluid.

The reservoir and any other part or whole of the water system may be flushed with a flushing fluid. Once flushed, the water system may then be filled with replacement water to be heated.

At least one mixing chamber may also be flushed. The at least one mixing chamber may be flushed to overflow.

The descaling process may be repeated one or more times. Once the descaling and flushing has been completed, the at least one fluid collection trough may then be retracted from the treatment position to the beverage dispensing position and the beverage preparation machine reset to the dispensing mode.

The steps in the method may be undertaken at any temperature. For example, the first flush may be undertaken with inlet water at the delivery temperature. Any treatment step may be undertaken with heated fluid. The second flush may be undertaken with inlet water at the delivery temperature. Heated water and/or cooled water may be used as required.

As a further improvement of the effectiveness of the treatment step, the treatment fluid may be provided with an active ingredient, for example, a detergent, an antibacterial agent and/or a descaling substance.

Depending on the nature of the treatment step, a temperature of the treatment fluid is at least 50 °C, preferably at least 60 °C. Even higher temperatures may be set for a descaling step, for example at least 80 °C, preferably at least 90 °C.

In one embodiment of the invention, at least one of the steps comprises the first flushing step and the second flushing step is carried out using cold or lukewarm water. Using cold, or preferably lukewarm water in the first flushing step effectively removes at least a substantial amount of residue in the flushed parts of the machine or component, while avoiding a solidification of proteins. Using cold or lukewarm water in the second flushing step cools down the flushed parts of the machine. A relatively fast cooling can be achieved using cool flushing water, however lukewarm water may alternatively be used, for example to mitigate against any risk of thermal shock, for example after a descaling treatment at high temperatures. The second flushing step may further remove any residues of detergents, or other treatment agents if these were used during the treatment step.

The at least one fluid collection trough may have any shape. The at least one fluid collection trough may have any size, but will preferably be large enough to contain at least one fluid dispensing outlet therein, and to at least partially immerse the at least one fluid dispensing outlet in treatment fluid. The at least partial immersion of the at least one fluid dispensing outlet in treatment fluid will preferably occur in all treatment modes, whether the treatment mode is a flushing only treatment mode, or a cleaning mode or a descaling treatment mode, to ensure that an outer surface of the at least one fluid dispensing outlet is treated.

The at least one fluid collection trough may be deployable in relation to one or more outlets. A fluid collection trough may be provided for a single outlet, but preferably, a single trough will be provided for all of the outlets which require treatment. A water-only outlet may not be provided relative to the at least one fluid collection trough.

The at least one fluid collection trough may be provided with one more dividers, particularly if more than one fluid dispensing outlet is to be treated at the same time. For example, the at least one fluid collection trough may be provided with one or more dividers to define a compartment therein for each at least one fluid dispensing outlet. The at least one fluid dispensing outlet is preferably configured to ensure that the at least one fluid collection trough fills to a level to treat an outer surface of the at least one fluid dispensing outlet. If this occurs, then at least a portion of an inner surface of the at least one fluid dispensing outlet will also be treated.

Preferably, the at least one fluid collection trough will not be filled to overflow.

One or more valves may be provided located at the outflow of the mixer, between the outlet and mixing chamber. The one or more valves may be controlled to ensure that the at least one fluid collection trough is filled to the required level.

One or more drain valves is preferably provided as an outlet from the at least one fluid collection trough. The one or more drain valves may be controlled to ensure that the at least one fluid collection trough is filled to the required level.

One or more drain valves may be sized relative to the at least one fluid dispensing outlet to ensure filling of the at least one fluid collection trough to the required level.

The at least one fluid collection trough may be shaped internally to ensure treatment of the at least one fluid dispensing outlet.

An outlet may be provided in an upper portion of the at least one fluid collection trough. Any upper outlet may be provided at a level above at least a portion of the at least one fluid dispensing outlet. More than one outlet may be provided in the at least one fluid collection trough, for example at least one lower outlet and at least one upper outlet.

The at least one fluid collection trough may be provided with a level sensor to ascertain the level of fluid within the at least one fluid collection trough to ensure that the at least one fluid collection trough does not overflow.

The at least one fluid collection trough is preferably driven between the beverage dispensing position and the treatment position. Any mechanism may be used. The at least one fluid collection trough may be provided at least partially within the housing. The housing may completely enclose the at least one fluid collection trough when in the beverage dispensing position. Alternatively, a rear end of the at least one fluid collection trough may be received in the housing and an outer end extend outside the housing through a shaped receiving opening to guide movement of the at least one fluid collection trough and to brace the at least one fluid collection trough in the treatment position.

In a preferred form, the at least one fluid collection trough is provided at a level substantially coplanar with the at least one fluid dispensing outlet and is driven horizontally, reciprocally between the beverage dispensing position and the treatment position.

### DETAILED DESCRIPTION OF THE INVENTION

In order that the invention may be more clearly understood one or more embodiments thereof will now be described, by way of example only, with reference to the accompanying drawings, of which:

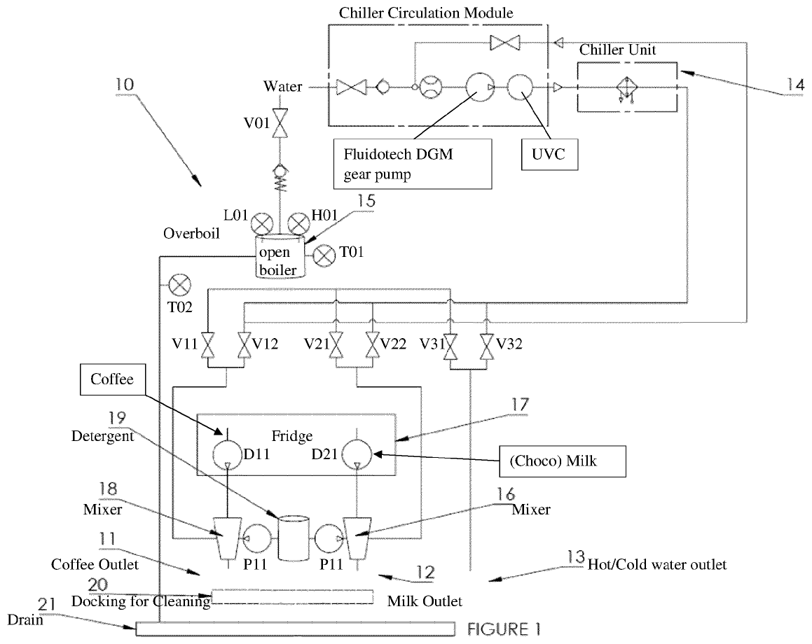

FIG. 1 is a process flow diagram of an autonomous treatment apparatus applied to a beverage preparation machine according to an embodiment.

FIG. 2 is an axonometric view from above of a biased outlet according to an embodiment in a dispensing position.

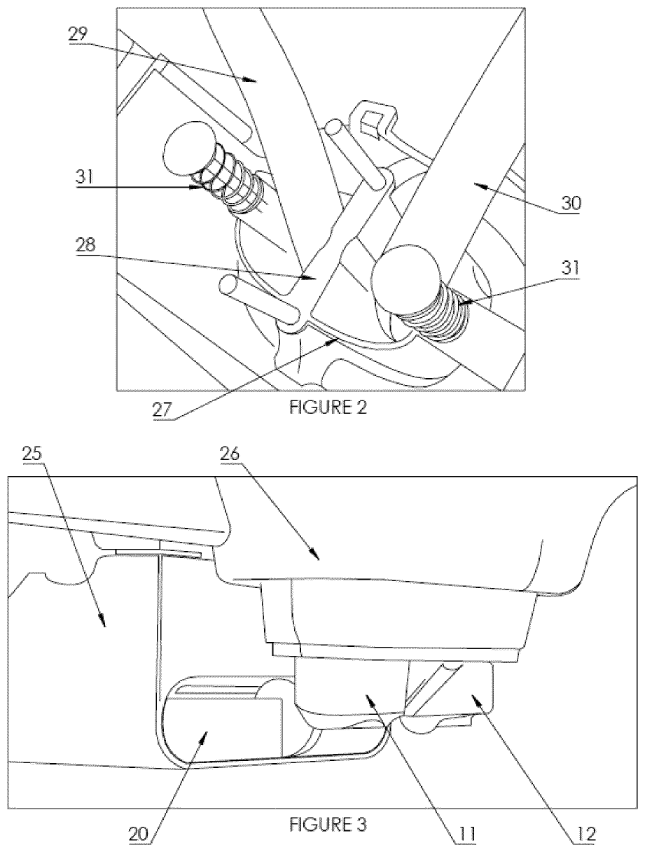

FIG. 3 is an axonometric view from the front of the biased outlet illustrated in FIG. 2 and a fluid collection trough in the dispensing position.

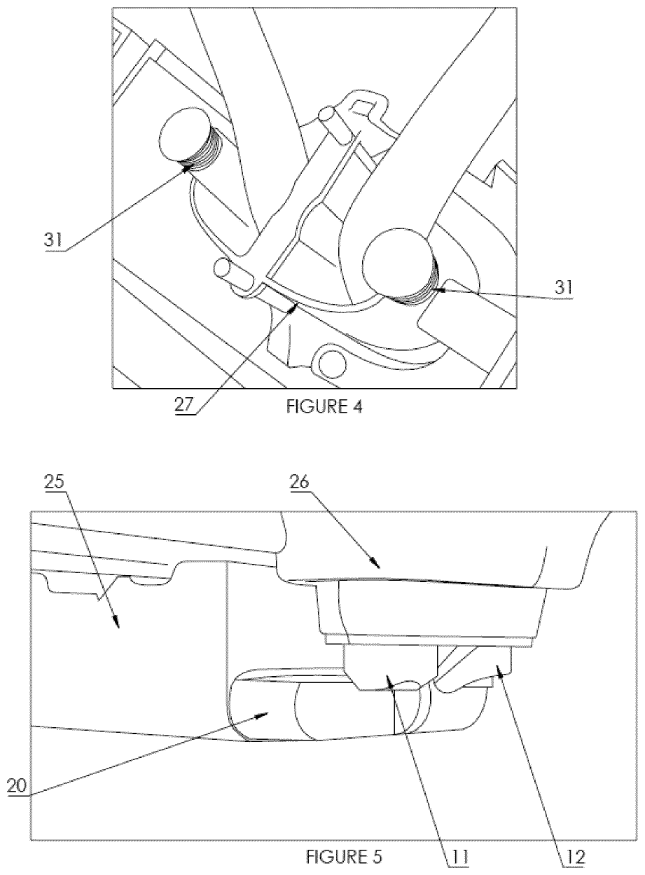

FIG. 4 is an axonometric view from above of a biased outlet according to an embodiment in a partially deployed position.

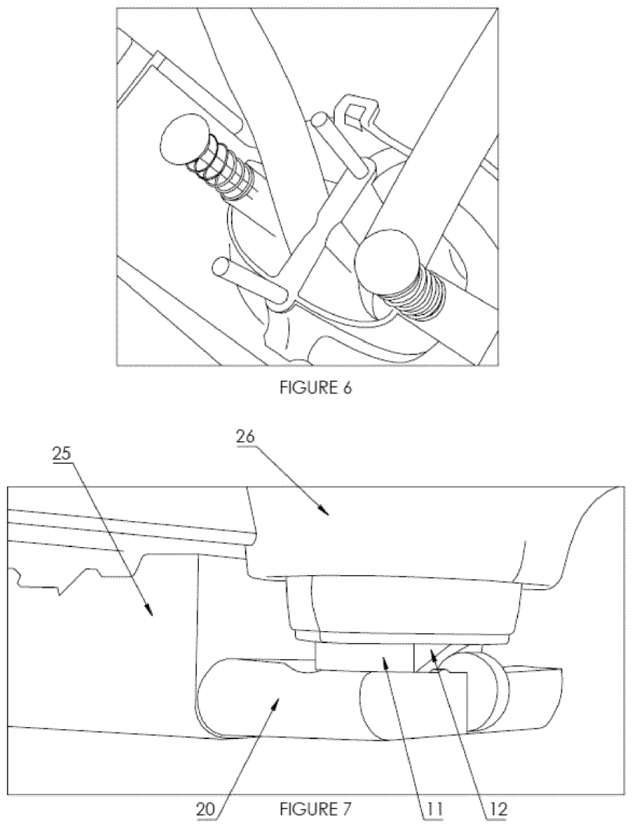

FIG. 5 is an axonometric view from the front of the biased outlet illustrated in FIG. 4 and a fluid collection trough in the partially deployed position.

FIG. 6 is an axonometric view from above of a biased outlet according to an embodiment in a treatment position.

FIG. 7 is an axonometric view from the front of the biased outlet illustrated in FIG. 6 and fluid collection trough in the treatment position.

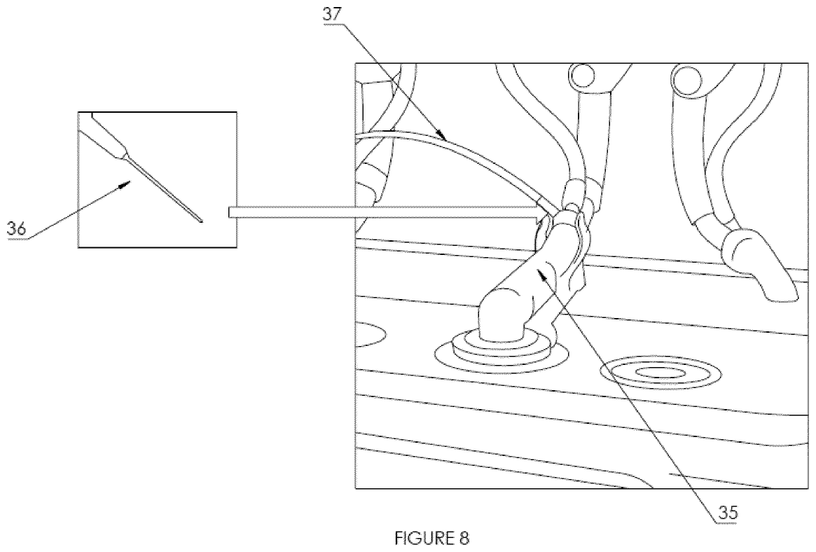

FIG. 8 is an axonometric front view of a fluid supply line with treatment injector according to an embodiment in place.

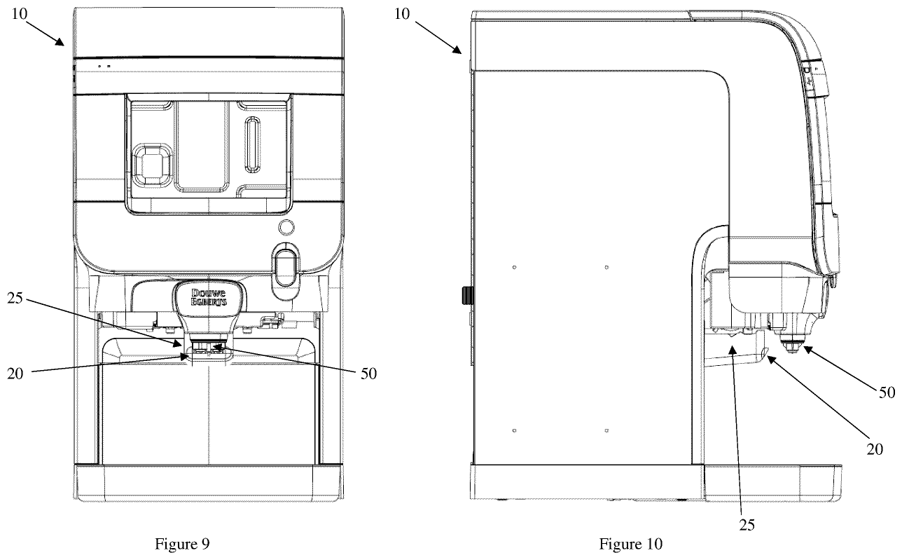

FIG. 9 is a front elevation view of a beverage preparation machine according to an embodiment.

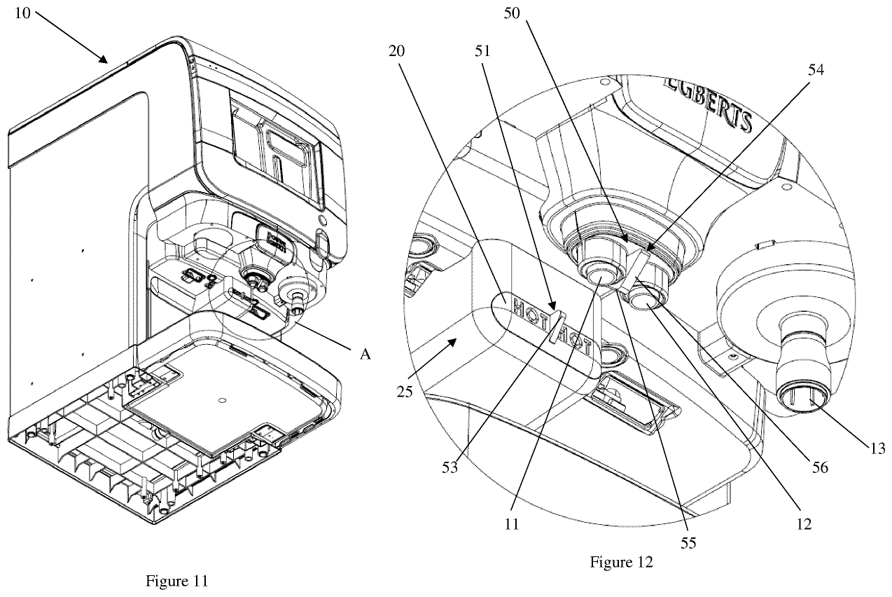

FIG. 10 is a side view of the beverage preparation machine illustrated in FIG. 9.

FIG. 11 is an axonometric view from below of the beverage preparation machine illustrated in FIG. 9.

FIG. 12 is a detailed view of the portion identified in FIG. 11 as ‘A’.

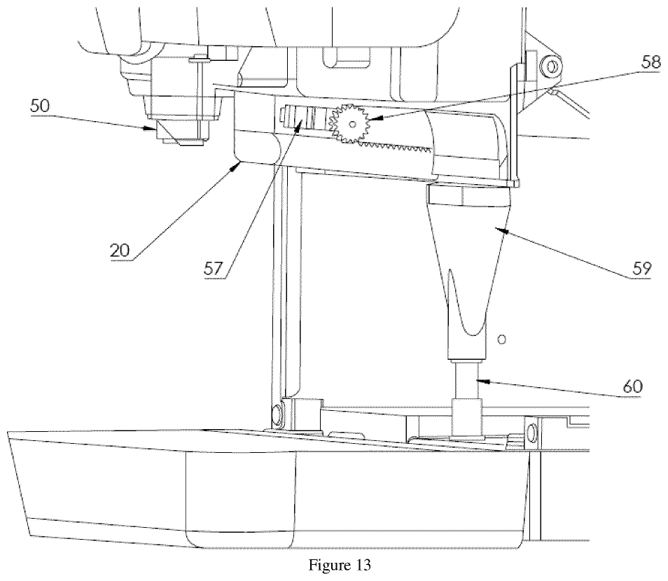

FIG. 13 is an axonometric view of the lower front portion of the beverage preparation machine illustrated in FIG. 9 with the housing of the fluid collection trough and outlets and the side of the machine removed.

A beverage preparation machine 10 configured to implement an autonomous treatment process is illustrated in terms of process flow features in FIG. 1.

The beverage preparation machine 10 illustrated comprises three fluid dispensing outlets, namely a coffee outlet 11, a milk outlet 12 and a hot/cold water outlet 13. The respective outlets are connected to a respective circuit to make coffee, flavoured milk and water and dispense from the machine via the outlets.

The hot/cold water outlet 13 is selectively connectable to a chiller unit 14 or an open boiler 15 through operation of valves V31 and V32.

The milk outlet 12 is associated with a mixer 16. The mixer is selectively connectable to a chiller unit 14 or an open boiler 15 through operation of valves V21 and V22 and also a source of milk D21 stored in a refrigerator 17.

The coffee outlet 11 is associated with a mixer 18. The mixer is selectively connectable to a chiller unit 14 or an open boiler 15 through operation of valves V11 and V12 and also a source of coffee D11 stored in a refrigerator 17.

Both the chiller unit 14 and open boiler 15 are fed from a water inlet. Operation of the respective valves can adjust the temperature of the water in any one of the circuits and direct fluid through the required circuit. As shown, a detergent reservoir 19 is associated with each mixer 16, 18, via pumps P11.

A fluid collection trough 20 (identified as ‘docking for cleaning’ in FIG. 1) positioned relative to the fluid dispensing outlet 11 and 12 and is moveable between a dispensing position separated from the coffee and milk dispensing outlets 11, 12 as shown in FIG. 3, to a treatment position below the coffee and milk dispensing outlets 11, 12 as shown in FIG. 7. When in the treatment position shown in FIG. 7, the coffee and milk dispensing outlets 11, 12 are positioned within the fluid collection trough 20 to clean an outer surface of the coffee and milk dispensing outlets 11, 12.

A drain 21 is provided connected at least to the trough 20 and the boiler overflow.

The beverage preparation machine 10 shown implements an autonomous treatment process including the steps of:
a. Monitoring at least one use parameter of the beverage preparation machine 10 whilst in a dispensing mode;
b. Automatically triggering the beverage preparation machine 10 into a treatment mode dependent upon the at least one use parameter, the treatment mode implementing a treatment method comprising the sub-steps of:
i. Deploy the fluid collection trough 20 from the beverage dispensing position shown in FIG. 3 to the treatment position shown in FIG. 7 below the coffee and milk dispensing outlets 11, 12;
ii. Flushing the coffee and milk dispensing outlets 11, 12 and at least one mixing chamber 16, 18 with a flushing fluid;
iii. treating at least one fluid receptacle in the beverage preparation machine with a treatment fluid (either one of the mixers or the boiler as explained below);
iv. Flushing the at least one fluid receptacle with a flushing fluid;
v. Retract the fluid collection trough from the treatment position into the beverage dispensing position; and
c. Returning the beverage preparation machine to the dispensing mode.

Although not shown, each mixing chamber 16, 18 will preferably include an agitation or stirring device to agitate or stir the ingredients once the ingredients have been provided into the mixing chamber 16, 18.

The autonomous treatment process may be based on at least one parameter relating to the use of the beverage preparation machine 10.

The autonomous treatment process may be triggered according to use of one or more of the ingredients. For example, if the beverage preparation machine is configured to use milk as an ingredient, any beverage preparation circuit which utilises milk as an ingredient may require treatment more often, for example once each day, than a beverage preparation circuit which utilises only water, which may only require treatment once per week. Further, any circuit which prepares and dispenses cold or cooled beverages may require treatment more often than a circuit which provides only hot beverages. For example, a cold or cooled beverage circuit may require treatment once each day, whereas a hot circuit may only require treatment once every few days or once per week.

The beverage preparation machine may be triggered into the treatment mode based on the level of use. For example, more intense use which creates a high throughput of material through the beverage preparation machine may trigger the treatment mode more often.

The treatment mode may be triggered based on the at least one use parameter in combination with at least one other parameter which may affect the operational efficiency of the beverage preparation machine. For example, water hardness may influence operational efficiency and therefore, a machine used in combination with harder water may require more frequent descaling than a machine used with softer water where use is at the same level of throughput. It is preferably the boiler and any hot water circuit that will be descaled.

The beverage preparation machine will preferably be provided with a controller (not shown) associated with one or more sensors to sense a flow or use of ingredients in order to measure the use of ingredients and/or any other parameter related to the ingredients, such as for example water hardness.

In an embodiment, in which the beverage preparation machine, and in particular any controller provided to control the autonomous cleaning process is provided with a defined threshold of use to trigger the autonomously process, if the defined threshold of use is not reached, then the autonomous cleaning process may be triggered according to a default time period.

Once the treatment mode has been triggered, the fluid collection trough 20 is deployed from the beverage dispensing position to the treatment position as is shown in FIGS. 3, 5 and 7. The fluid collection trough 20 is preferably deployed to the treatment position shown in FIG. 7 before any treatment begins in order to catch any flushing/treatment fluid from the outlets 11, 12 and/or any remaining material from a beverage preparation circuit.

As shown in FIG. 2 to 7, the deployment of the fluid collection trough 20 may cause movement in the dispensing outlets 11, 12.

The dispensing outlets 11, 12 of the illustrated embodiment are mounted for movement relative to a mounting portion of the beverage preparation machine 10. In many embodiments, the dispensing outlets 11, 12 are substantially vertically oriented. The dispensing outlets 11, 12 shown are movable between a lowered, dispensing position (in the beverage dispensing position FIG. 3 and the treatment position, FIG. 7) and a raised position (FIG. 5) to allow the trough 20 to pass under the dispensing outlets 11, 12.

As shown in FIGS. 2, 4 and 6, dispensing outlets 11, 12 are biased into a lowered, dispensing position and movement of the fluid collection trough 20 forces the dispensing outlets 11, 12 upwardly against the bias and then the bias returns the dispensing outlets 11, 12 to the lowered position.

As shown in FIG. 3, in the dispensing position, the dispensing outlets 11, 12 are in the lowered position but outside the fluid collection trough 20. In the treatment position shown in FIG. 7, the dispensing outlets 11, 12 are in the lowered position but inside the fluid collection trough 20.

In the illustrated configuration, the dispensing outlets 11, 12 have a V-tapered lower end with a downwardly angled end portion on a side facing the fluid collection trough 20 and an upwardly angled end portion on a side facing away from the fluid collection trough 20. The provision of the angled end portions on the dispensing outlets 11, 12 causes the dispensing outlets 11, 12 to be raised against the bias, as the dispensing outlets 11, 12 move between positions.

In the illustrated form, the fluid collection trough 20 moves laterally in a horizontal direction. Preferably, the movement of the fluid collection trough 20 is reciprocal between the beverage dispensing position and the treatment position.

The fluid collection trough 20 shown is sufficiently large to contain the dispensing outlets 11, 12 therein, and to at least partially immerse the dispensing outlets 11, 12 in treatment fluid.

The dispensing outlets 11, 12 and/or trough 20 are configured to ensure that the fluid collection trough 20 fills to a level to treat an outer surface of the dispensing outlets 11, 12. If this occurs, then at least a portion of an inner surface of the dispensing outlets 11, 12 will also be treated.

Preferably, the fluid collection trough 20 will not be filled to overflow.

One or more drain valves is preferably provided as an outlet from the fluid collection trough 20. The one or more drain valves may be controlled to ensure that the at least one fluid collection trough is filled to the required level.

In use, the fluid collection trough 20 is driven between the beverage dispensing position and the treatment position. Any mechanism may be used. The at least one fluid collection trough may be provided at least partially within a housing 25. The housing 25 may completely enclose the fluid collection trough 25 when in the beverage dispensing position as shown in FIG. 3. A rear end of the fluid collection trough 20 remains received in the housing 25 and an outer end extends outside the housing 25 through a shaped receiving opening to guide movement of the fluid collection trough 20 and to brace the fluid collection trough in the treatment position shown in FIG. 7. This will also minimise deflection of the fluid collection trough 25 during movement, which in turn forces the dispensing outlets 11, 12 upwardly against the bias.

The fluid collection trough 20 is provided at a level substantially coplanar with the dispensing outlets 11, 12 and is driven horizontally, reciprocally between the beverage dispensing position and the treatment position.

In the illustrated embodiment, the dispensing outlets 11, 12 are provided in a single body 27 which is divided by a central wall 28 which is mounted within a housing 26. A supply line 29 is provided for outlet 11 and a second supply line 30 is provided for outlet 12. As mentioned above, the dispensing outlets 11, 12 are biased downwardly. Any biasing mechanism may be used. In the illustrated embodiment, the body 27 is biased downwardly using a pair of springs 31 mounted about upright posts.

FIG. 4 shows the pair of springs 31 are compressed as the trough 20 moves past the lower end of the dispensing outlets 11, 12, forcing the body 27 upwardly to allow the trough 20 to pass beneath the temporarily raised dispensing outlets 11, 12 as shown in FIG. 5.

In FIG. 6, the body 27 has returned to the position illustrated in FIG. 3 as the trough 20 is now positioned beneath the lower end of the dispensing outlets 11, 12 which are located within the trough 20 for treatment and is braced by the housing 25.

According to a preferred embodiment, following deployment of the fluid collection trough 20, a flushing step occurs in which the dispensing outlets 11, 12 and at least one mixing chamber 16, 18 are flushed with a flushing fluid. An initial flushing step may occur after deployment, and before treatment. An initial flushing step may flush any leftover or remaining fluid from one or more beverage dispensing circuits of the beverage dispensing machine before treatment occurs.

Where at least one mixing chamber 16, 18 is flushed, the flush preferably proceeds until the at least one mixing chamber 16, 18 overflows in order to ensure that the flushing has reached at least the normal use level of the at least one mixing chamber 16, 18.

Once the initial flush step has been completed, if the treatment to be undertaken is a cleaning step, then any outlet valve from the at least one mixing chamber 16, 18 is closed in order to allow the mixing chamber 16, 18 to be filled with cleaning fluid. Cleaning fluid is then be introduced into the mixing chamber 16, 18. The cleaning fluid may be or include a cleaning agent and/or water. Where a mixture is used, an amount of cleaning agent or detergent is dosed into an amount of water inlet into the at least one mixing chamber 16, 18. As shown in FIG. 8, the detergent can be dosed into the water inlet 35 to the at least one mixing chamber 16, 18 via a needle valve 36 supplied from the detergent reservoir 19 using a supply conduit 37 in order to prevent the Venturi effect drawing cleaning agent out during normal beverage dispensing operation.

In a preferred form, the respective dosing pump P11 is operated for a period in the reverse direction at the end of the dosing step in order to prevent cleaning agent being drawn into the water inlet 35 during normal beverage dispensing operation.

Preferably, sufficient cleaning fluid is provided to fill the at least one mixing chamber 16, 18. In a preferred embodiment, sufficient cleaning fluid is used to overflow the at least one mixing chamber 16, 18 in order to ensure that the cleaning fluid fills the at least one mixing chamber 16, 18 to above the normal use level.

The treatment step may include a soaking step in which cleaning fluid is left in the at least one mixing chamber 16, 18 for a period of time before being emptied.

The agitator or stirring apparatus associated with the at least one mixing chamber 16, 18 may be operated during a cleaning step/soaking step to provide agitation or turbulence in the cleaning fluid within the at least one mixing chamber 16, 18. When operated during a cleaning step/soaking step, and agitator or stirring apparatus may be operated at a low speed.

Once the cleaning step and/or soaking step has been completed, an outlet valve from the mixing chamber 16, 18 is preferably opened to empty the mixing chamber 16, 18. An agitator or stirring apparatus associated with the mixing chamber 16, 18 can be operated during the emptying of the mixing chamber. Preferably, the agitator or stirring apparatus may be operated at a medium speed during the emptying of the mixing chamber 16, 18.

Once the mixing chamber 16, 18 has been emptied of cleaning fluid, the outlet valve is preferably closed.

Following closing of the outlet valve, the mixing chamber 16, 18 may undergo a flushing step in which the mixing chamber 16, 18 is flushed with a flushing fluid. This may be a second flush to flush the mixing chamber 16, 18 of any remaining cleaning fluid. Preferably, the second flushing step may occur to overflow the mixing chamber 16, 18 to ensure that the mixing chamber is flushed completely.

The cleaning/soaking step may occur more than once in any cleaning cycle. For example, for beverages which include milk, the cleaning/soaking step may occur more than once, but may be undertaken only once for beverages which are water-based such as tea or coffee for example.

Once the second flushing step has been completed, the fluid collection trough 20 is then be moved or retracted from the treatment position to the beverage dispensing position and the beverage preparation machine returned to the normal, dispensing mode.

The autonomous treatment process may be a descaling process instead of or as well as a cleaning process.

In a preferred descaling process, the fluid collection trough 20 is deployed. The fluid dispensing outlets 11, 12 and mixing chamber 16, 18 of the beverage preparation machine can then be flushed with a flushing fluid.

In the treating step, when the beverage preparation machine is being descaled, descaling fluid may be introduced into the boiler 15 of the beverage preparation machine. The descaling fluid may be or include a descaling agent. The descaling agent may be dosed into carrier such as water. The descaling agent may be dosed into the carrier using a dosing pump.

The boiler 15 may be filled with descaling fluid to overflow in order to ensure that the descaling fluid reaches the normal operating or fill level of the boiler 15.

During any descaling process, the temperature of the water in the boiler 15 may be changed, for example lowered.

The descaling process may include a soaking step in which the descaling fluid remains in the boiler 15 for a period of time.

During the descaling process, one or more outlet valves from the boiler 15 may be opened and closed. Preferably, at least one outlet valve from the boiler 15 may be opened and then closed at one or more times during the descaling process to descale any valves associated with the boiler 15. If this occurs, additional descaling agent and/or water may be added into the boiler 15 to maintain the level of descaling fluid within the boiler.

At the end of the descaling process, the boiler 15 will preferably be drained of descaling fluid.

The boiler 15 may be flushed with a flushing fluid. The flushing fluid may fill the boiler 15 to overflow to ensure flushing to at least a normal operational level. Once flushed, the boiler 15 may then be filled with replacement water to be heated.

At least one mixing chamber 16, 18 may also be flushed. The mixing chamber 16, 18 may be flushed to overflow.

The descaling process may be repeated one or more times. Once the descaling and flushing has been completed, the fluid collection trough 20 may then be retracted from the treatment position to the beverage dispensing position and the beverage preparation machine reset to the dispensing mode.

The steps in the method may be undertaken at any temperature. For example, the first flush may be undertaken with inlet water at the delivery temperature. Any treatment step may be undertaken with heated fluid. The second flush may be undertaken with inlet water at the delivery temperature. Heated water and/or cooled water may be used as required.

An embodiment of a beverage preparation machine 10 is illustrated in FIGS. 9 to 13.

The outlet assembly 50 and the fluid collection trough 20 are each shown in overall position on a forward side of a beverage preparation machine 10 in FIGS. 9 to 11. The outlet assembly 50 and the fluid collection trough 20 are shown in more detail in FIG. 12.

As shown in FIG. 12, the fluid collection trough 20 is shown with a forward or outer wall which has an abutment tab 51 provided on an outer side thereof and facing the coffee outlet 11 and milk outlet 12. The abutment tab has an angled wall which is angled upwardly away from the outer wall of the fluid collection trough 20 and which has a forward abutment apex 53.

The outlet assembly 50 includes a biased dual outlet including the coffee outlet 11 and milk outlet 12. Positioned between the coffee outlet 11 and milk outlet 12 is an abutment tab 54. Abutment tab 54 has a pair of opposed ramped surfaces, namely an inner ramp surface 55 and an outer ramp surface 56. The inner ramp surface 55 faces the fluid collection trough 20 and is aligned with the abutment tab 51 provided on an outer side of the forward wall of the fluid collection trough 20.

In use and as the fluid collection trough 20 is driven outwardly from the dispensing position to the treatment position, the forward abutment apex 53 of the abutment tab 51 abuts the inner ramp surface 55 and as the deployment outwardly continues, the forward abutment apex 53 of the abutment tab 51 slides over the inner ramp surface 55, which in turn forces the dual outlet upwardly, allowing the forward or outer wall of the fluid collection trough 20 to pass under the biased dual outlet including the coffee outlet 11 and milk outlet 12. Once the forward or outer wall of the fluid collection trough 20 has passed beneath the biased dual outlet including the coffee outlet 11 and milk outlet 12, the abutment is lost and the bias forces the biased dual outlet including the coffee outlet 11 and milk outlet 12 downwardly to be located within the fluid collection trough 20 for treatment.

In moving the fluid collection trough 20 from the treatment position to the dispensing position, the reverse occurs, with the inner side of the forward or outer wall of the fluid collection trough 20 abuts the outer ramp surface 56 of the abutment tab 54 and as the movement inwardly continues, the inner side of the forward or outer wall of the fluid collection trough 20 slides over the outer ramp surface 56, which in turn forces the dual outlet upwardly, allowing the forward or outer wall of the fluid collection trough 20 to pass under the biased dual outlet including the coffee outlet 11 and milk outlet 12. Once the forward or outer wall of the fluid collection trough 20 has passed beneath the biased dual outlet including the coffee outlet 11 and milk outlet 12, the abutment is lost and the bias forces the biased dual outlet including the coffee outlet 11 and milk outlet 12 downwardly to be located in the dispensing position once again, with the fluid collection trough 20 stored spaced from the coffee outlet 11 and milk outlet 12 in the position shown in FIG. 10.

It is to be noted that the embodiment of the fluid collection trough 20 illustrated in FIGS. 3, 5 and 7 has a rounded abutment tab and the dual outlet has an abutment tab which together, have the same technical effect as the angled abutment tab 51 and abutment tab 54 illustrated in FIG. 12.

FIG. 13 shows one mechanism which could be used to drive movement of the fluid collection trough 20, namely the provision of plurality of linear teeth on the fluid collection trough 20 and a motor 57 which drives reversible rotation of a toothed wheel 58 to move the fluid collection trough 20. Also shown in FIG. 13 is an enlarged rear drain 59, spanning the width of the rear end of the fluid collection trough 20, which connects to a smaller lower drain conduit 60 to receive fluid from the rear end of the fluid collection trough 20.

The one or more embodiments are described above by way of example only. Many variations are possible without departing from the scope of protection afforded by the appended claims.

1. An autonomous treatment process for a beverage preparation machine including the steps of:
a. Automatically triggering the beverage preparation machine into a treatment mode, the treatment mode implementing a treatment method comprising the sub-steps of:
i. Deploying at least one fluid collection trough from a beverage dispensing position separated from at least one fluid dispensing outlet of the beverage preparation machine to a treatment position below the at least one fluid dispensing outlet of the beverage preparation machine;
ii. Flushing the at least one fluid dispensing outlet and at least one mixing chamber of the beverage preparation machine with a flushing fluid;
iii. Retract the at least one fluid collection trough from the treatment position to the beverage dispensing position; and
b. Returning the beverage preparation machine to the dispensing mode.

2. An autonomous treatment process as claimed in claim 1 further including the steps of
Treating at least one fluid receptacle in the beverage preparation machine with a treatment fluid in a treatment step, following the flushing step (ii); and
Second flushing the at least one fluid receptacle with a flushing fluid in a second flushing step, following the treating step and before the retracting step (iii).

3. An autonomous treatment process as claimed in claim 1 wherein the autonomous treatment process is triggered according to at least one use parameter and includes the step of monitoring at least one use parameter whilst in a dispensing mode.

4. An autonomous treatment process as claimed in claim 1 wherein the autonomous treatment process is triggered according to time schedule.

5. An autonomous treatment process as claimed in claim 1 wherein deploying the at least one fluid collection trough causes movement in the at least one fluid dispensing outlet.

6. An autonomous treatment process as claimed in claim 5 wherein the at least one fluid dispensing outlet is biased into a lowered, dispensing position and movement of the at least one fluid collection trough forces the at least one fluid dispensing outlet upwardly against the bias and then the bias returns the at least one fluid dispensing outlet to the lowered position, within the at least one fluid collection trough.

7. An autonomous treatment process as claimed in claim 1 wherein during flushing of the at least one mixing chamber, the flushing proceeds until the at least one mixing chamber overflows.

8. An autonomous treatment process as claimed in claim 2 wherein the treatment step is a cleaning step, then an outlet valve from the at least one mixing chamber is closed and the at least one mixing chamber filled with cleaning fluid.

9-10. (canceled)

11. An autonomous treatment process as claimed in claim 8 wherein cleaning fluid is provided to fill the at least one mixing chamber to overflow the at least one mixing chamber.

12. An autonomous treatment process as claimed in claim 8 further including a soaking step after the at least one mixing chamber is filled in which cleaning fluid is left in the at least one mixing chamber.

13. (canceled)

14. An autonomous treatment process as claimed in claim 8 further comprising a step of operating an agitator or stirring apparatus associated with the at least one mixing chamber.

15. An autonomous treatment process as claimed in claim 8 wherein the second flushing step occurs to overflow the at least one mixing chamber.

16. An autonomous treatment process as claimed in claim 2 wherein the treatment step is a descaling process, in which descaling fluid is introduced into a water system of the beverage preparation machine.

17. (canceled)

18. An autonomous treatment process as claimed in claim 16 wherein the water system or one or more process components is flushed with a flushing fluid in the second flushing step.

19. A beverage preparation machine for an autonomous treatment process, the beverage preparation machine comprising at least one fluid dispensing outlet and at least one fluid collection trough positioned relative to the at least one fluid dispensing outlet and moveable between a dispensing position separated from at least one fluid dispensing outlet to a treatment position below at least one outlet wherein when in the treatment position, the at least one fluid dispensing outlet is positioned within the at least one fluid collection trough to clean an outer surface of the at least one fluid dispensing outlet.

20. An autonomous treatment beverage preparation machine, the beverage preparation machine comprising at least one fluid dispensing outlet and at least one fluid collection trough positioned relative to the at least one fluid dispensing outlet and moveable between a dispensing position separated from at least one fluid dispensing outlet to a treatment position below at least one outlet wherein when in the treatment position, the at least one fluid dispensing outlet is positioned within the at least one fluid collection trough to clean an outer surface of the at least one fluid dispensing outlet, automatically triggering a treatment mode in which the at least one fluid collection trough deploys from a dispensing position separated from at least one fluid dispensing outlet of the beverage preparation machine to a treatment position below the at least one fluid dispensing outlet of the beverage preparation machine, an outlet and mixing chamber of the beverage preparation machine is flushed with a flushing fluid, the at least one fluid collection trough is retracted from the treatment position to the dispensing position and the beverage preparation machine is returned to the dispensing mode.

21. (canceled)

22. A beverage preparation machine as claimed in claim 19 wherein the at least one fluid dispensing outlet is biased into a lowered position wherein the at least one fluid collection trough contains the at least one fluid dispensing outlet therein, and at least one fluid dispensing outlet is at least partially immersed in treatment fluid and the at least one fluid collection trough forces the at least one fluid dispensing outlet to be raised against the bias by the movement of the at least one fluid collection trough.

23. A beverage preparation machine as claimed in claim 19 wherein the at least one fluid dispensing outlet has a tapered lower end to abut a portion of the at least one fluid collection trough as the least one fluid collection trough moves between the dispensing position and the treatment position and back.

24. A beverage preparation machine as claimed in claim 19 wherein the at least one fluid collection trough is mounted for reciprocal movement laterally in a horizontal direction.

25. A beverage preparation machine implementing the autonomous treatment process of claim 1.
